(19) United States
(12) Patent Application Publication
(10) Pub. No.: US 2002/0074809 A1
(43) Pub. Date: Jun. 20, 2002

(54) Lock arrangement

(76) Inventor: Sidney Edward Fisher, West Midlands (GB)

Correspondence Address: CARLSON, GASKEY & OLDS, P.C., 400 WEST MAPLE ROAD, SUITE 350, BIRMINGHAM, MI, 48009, US

(21) Appl. No.: 09/995,535

(22) Filed: Nov. 28, 2001

(30) Foreign Application Priority Data
Nov. 29, 2000 (GB) GB 0029064.3

(51) Int. Cl. E05C 3/06

(52) U.S. Cl. 292/216

(57) ABSTRACT

A lock arrangement including a lock having an unlocked and locked condition, the lock arrangement further including an actuable element having a first position at which the lock is unlocked and a second position at which the lock is locked, the lock arrangement further including means for ensuring the actuable element passes through a transitory position in changing the state of the lock from at least one of the locked and unlocked conditions to the other of the locked and conditions in which one of the locked and unlocked conditions of the actuable element is on the path of the actuable element between the transitory and the other of the locked and locked positions.

### BACKGROUND OF THE INVENTION

The present invention relates to lock arrangements, and in particular lock arrangements for use in cars (automobiles).

Known car doors include an inside release handle operable to open the car door, and also operable to lock the car door. The handle has three positions with the door release position being at one extreme and the lock position being at the other extreme, with the unlocked (but not released) position been part way between the locked and released positions.

Thus when the handle is in the unlocked position, movement of the handle to the release position opens the door. Furthermore when the handle is in locked position it is possible to move the handle as a single operation through the unlocked position to the release position. This is the normal sequence of events when the car is stationary and locked and an occupant of the vehicle wishes to exit the vehicle.

However, an occupant wishing to unlock the door (without opening the door) would normally move the handle from the locked to the unlocked position but can inadvertently move the handle pass the unlocked position to the release position. If this inadvertent operation is carried out whilst the vehicle is travelling at speed then there is a danger of the door opening with obvious safety implications of the occupants of the vehicle.

### SUMMARY OF THE INVENTION

An object of the present invention is to provide an improved form of lock arrangement.

Thus according to the present invention there is provided a lock arrangement including a lock having an unlocked and locked condition, the lock arrangement further including an actuable element having a first position at which the lock is unlocked and a second position at which the lock is locked, the lock arrangement further including means for ensuring the actuable element passes through a transitory position when changing the state of the lock from at least one of the locked and unlocked conditions to the other of the locked and conditions in which one of the locked and unlocked conditions of the actuable element is on the path of the actuable element between the transitory and the other of the locked and locked positions.

### BRIEF DESCRIPTION OF THE DRAWINGS

The invention will now be described, by way of example only, with reference to the accompanying drawings in which:

FIGS. 1 to 4 show a view of a lock arrangement according to the present invention in an unlocked, locked, transitory and unlatched position,

FIG. 5 shows the views of FIGS. 1 to 4 overlaid for comparison purposes,

FIG. 6 is a view of a further embodiment of a lock arrangement according to the present invention;

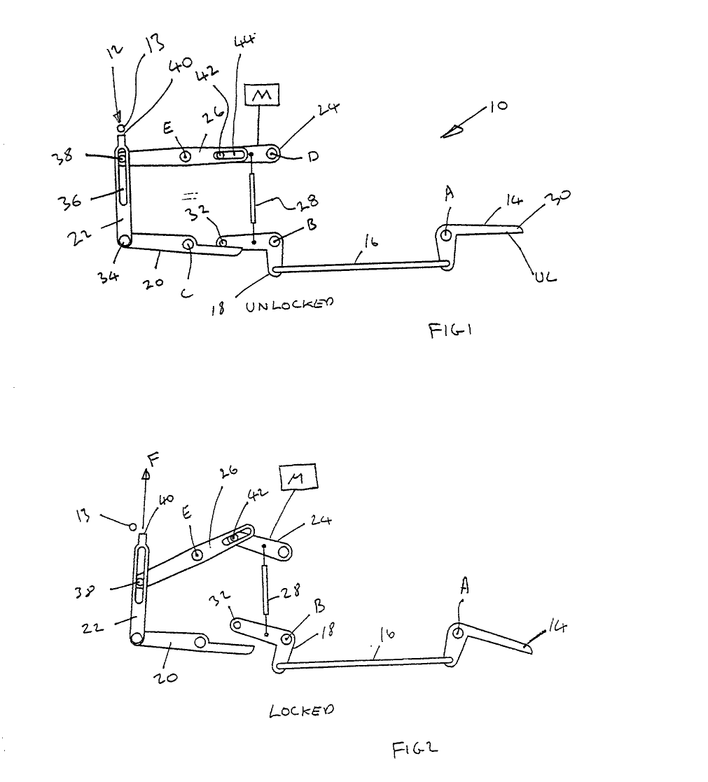

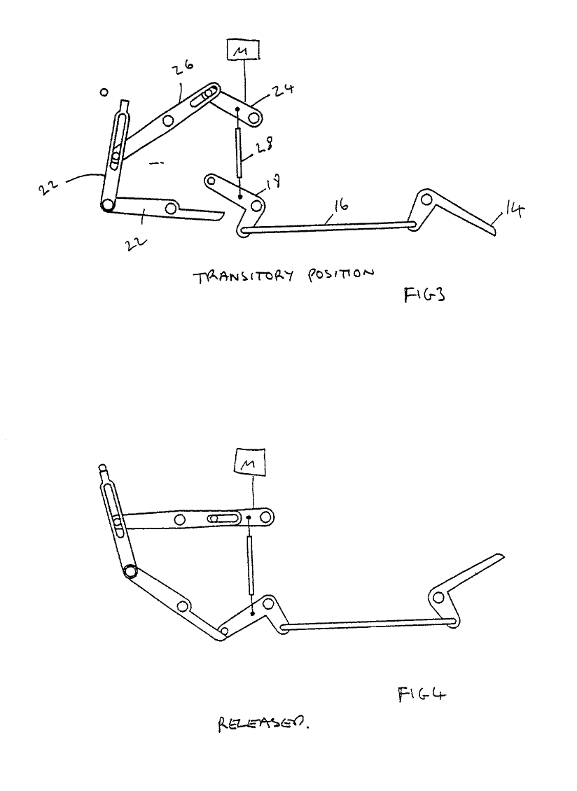

FIG. 1.1 is an exploded view of a means of the present invention;

FIG. 1.2 is a developed view of the cam arrangements of FIGS. 1.1;

FIG. 1.3 is a partial schematic view of a further embodiment of a means of the present invention;

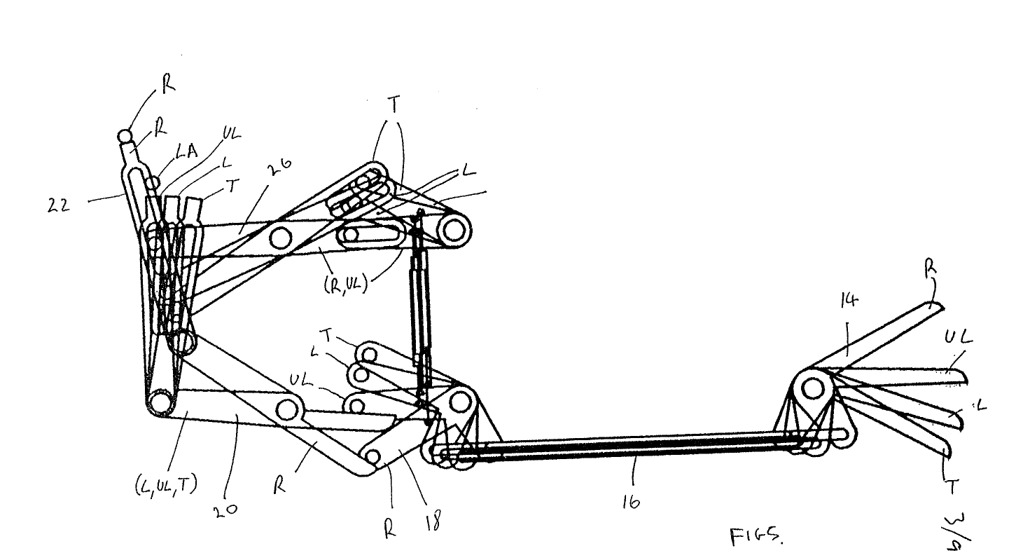

FIG. 2.1 is a view of a means of the present invention;

FIG. 2.2 is an exploded view of FIG. 2.1;

FIGS. 2.3 to 2.6 show an axial view of some of the components of the means of FIG. 2.1 in various positions;

FIG. 2.7 shows an axial view of the cam arrangement of FIG. 2.1 in isolation; and

FIG. 2.8 shows a partial view of FIG. 2.7.

### DETAILED DESCRIPTION OF THE PREFERRED EMBODIMENT

With reference to FIGS. 1 to 5 there is shown a lock arrangement 10 which incorporates a latch 12, only part of which is shown. Lock arrangement 10 includes an inside handle 14, a link 16, and inside release lever 18, an outside release lever 20, a common release lever 22, an inside lock lever 24, an outside lock lever 26 and an extension spring 28.

Inside handle 14 is pivotally mounted about axis A on the inside of a door and includes a manually actuable portion 30. Inside handle 14 is connected to inside release lever 18 by link 16. Inside release lever 18 is pivotally mounted about axis B and includes a pin 32 for engagement with outside release lever 20. Inside release lever 18 is further connected to inside lock lever 24 via extension spring 28. Outside release lever 20 is pivotally mounted about axis C and is connected via a connection (not shown) to an outside door handle (not shown).

A pivot pin 34 operably connects outside release lever 20 to common release lever 22, allowing the common release lever 22 to pivot relative to the outside release lever 20.

Common release lever 22 includes an elongate slot 36 within which moves pin 38 of outside lock lever 26. Common release lever 22 further includes a release abutment 40 for engagement with the pin 13 of latch 12.

Extension spring 28 includes helical coils which are normally coil bound. As such it can act as a rod of fixed length in compression. It can also act as a rod of fixed length under tension when the tensile load is less than that required to separate the coils of the spring, following which it becomes extensively elastic.

Inside lock lever 24 is pivotally mounted about axis D and includes a pin 42 which moves within slot 44 of outside lock lever 26. Outside lock lever 26 is pivotally mounted about axis E. A means M (shown schematically in FIG. 1) is connected to the inside lock lever, the purpose of which will be described further below.

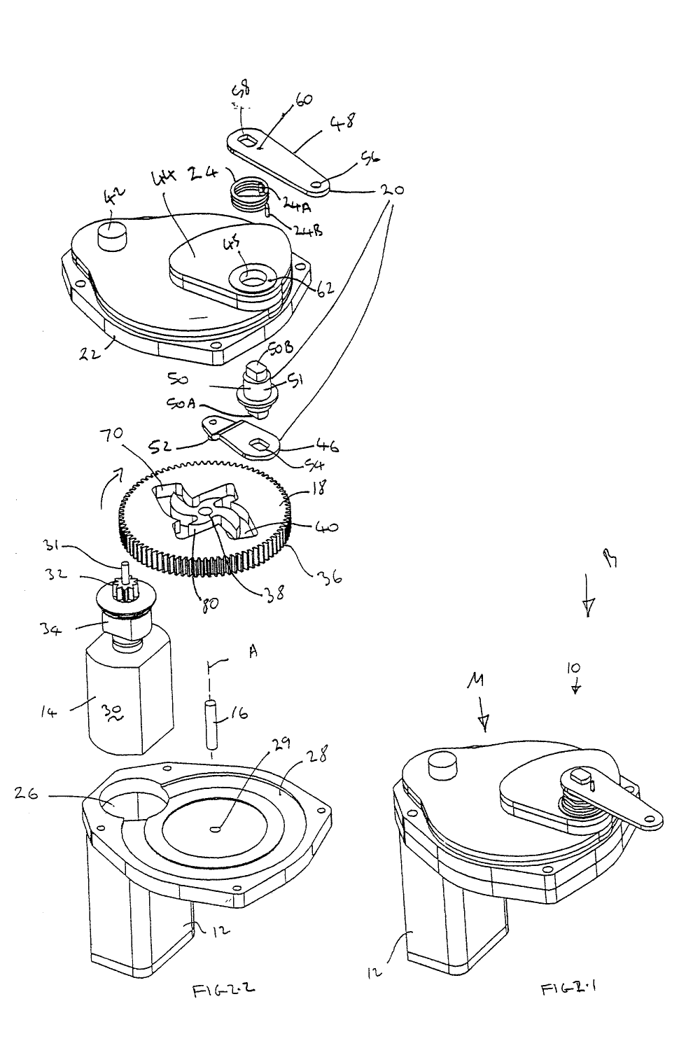

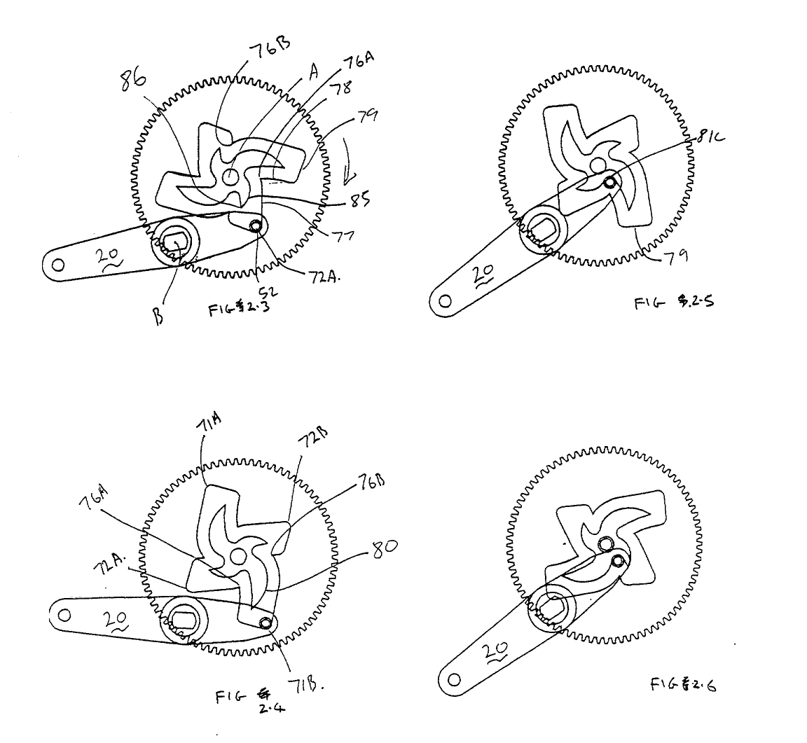

Latch 12 is of known construction and typically might include a rotationing claw (latch bolt) which releasably engages a striker mounted on fixed structure of the vehicle such as a B post or a C post. The claw is retained in a closed position by a pawl operably connected to pin 13. Movement of pin 13 from the latch position LA (see FIG. 5) to the release position R causes the pawl to disengage the claw, thus allowing the striker to be released and hence the allowing the door to open.

Consideration of FIG. 5 shows the various components of the lock arrangement in various positions wherein R refers to the released position of a particular component, U refers to the unlocked position of the particular component, L refers to the locked position of a particular component and T refers to the transitory position of a particular component. It should be noted that inside handle 14, inside release lever 18, and common release lever 22 each have four positions. However, outside release lever 20 remains in the same position when the lock arrangement is in a locked, unlocked or transitory position. The outside release lever 20 only moves from this position to the release position when the latch is released.

It should also be noted that the outside lock lever 46 and inside lock lever 24 remain in the same position when the lock arrangement is in the released or unlocked condition. However, these two components do move to a locked position and also to a different transitory position.

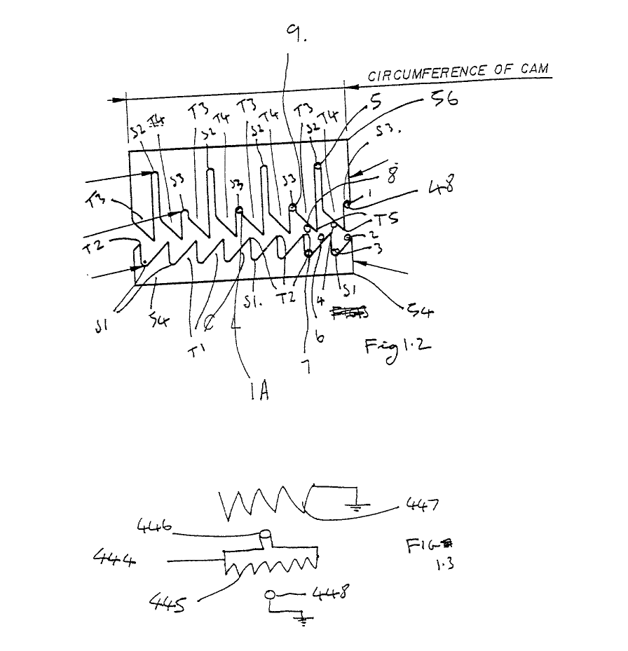

Consideration of FIG. 1 shows the lock arrangement in an unlocked condition. Thus movement of the inside handle to the released position causes the link 16 to rotate the inside release lever anticlockwise about axis B causing pin 32 to engage outside release lever 20 causing it in turn to rotate clockwise about axis C which results in pivot pin 34 moving common release lever 22 generally vertically when viewing FIG. 1 such that release abutment 40 engages and moves pin 13 to the released position as shown in FIG. 4. It should be noted that during this release movement pin 38 retains stationary and slides within slot 36 and extension spring 28 is caused to extend.

The outside release lever 20 can be independently moved by an outside door handle to open the latch and under such circumstances outside release lever 20, common release lever 22 and pin 12 move in a similar manner to that when the inside handle is moved but the inside handle 14, link 16 and inside release lever 18 remains stationary under these circumstances.

Consideration of FIG. 2 shows the lock arrangement in a locked condition wherein the inside handle 14 has been rotated clockwise about axis A relative to the position as shown in FIG. 1 resulting in inside release lever 18 rotating clockwise causing the extension spring 28 to act in compression as a solid rod which in turn causes the inside lock lever 24 to also rotate clockwise.

The clockwise rotation of the inside lock lever 24 has caused the pin 42 to rotate the outside lock lever 26 anticlockwise about axis E resulting in pin 38 causing the combined release lever 22 to rotate clockwise when compared with FIG. 1. It should be noted that the position of the outside release lever 20 has shown in FIGS. 1 and 2 remains unchanged. Furthermore consideration of FIG. 2 shows that the release abutment 40 is no longer in line with pin 13. Thus operation of the outside door handle to move the outside release lever will result in the common release lever 22 moving in the direction of arrow F such that release abutment 40 bypasses pin 13 and hence the latch is not released.

Furthermore if the inside handle 14 where to be moved to the release position link, 16 would cause inside release lever 18 to rotate anticlockwise such that pin 32 is caused to contacted and rotated outside release lever 20 in a clockwise direction and again release abutment 40 would move in the direction of arrow F bypassing pin 13. Under these circumstances means M prevents the inside lock lever from moving to its unlocked position (as will be further described below) and hence extension spring 28 is caused to extend when an attempt is made to open the latch by the inside handle when the latch assembly is in the locked condition as shown in FIG. 2.

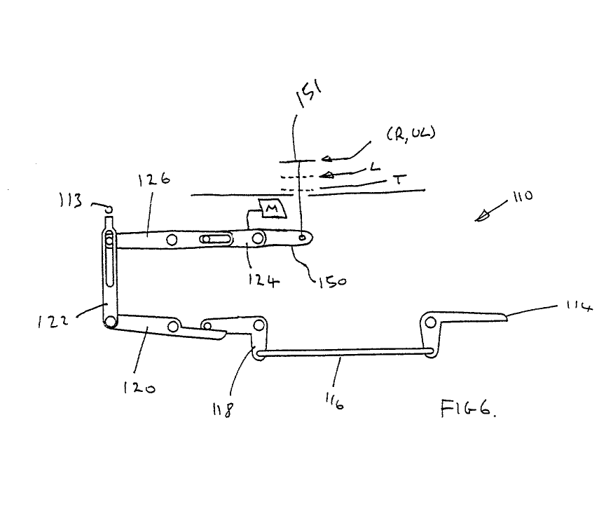

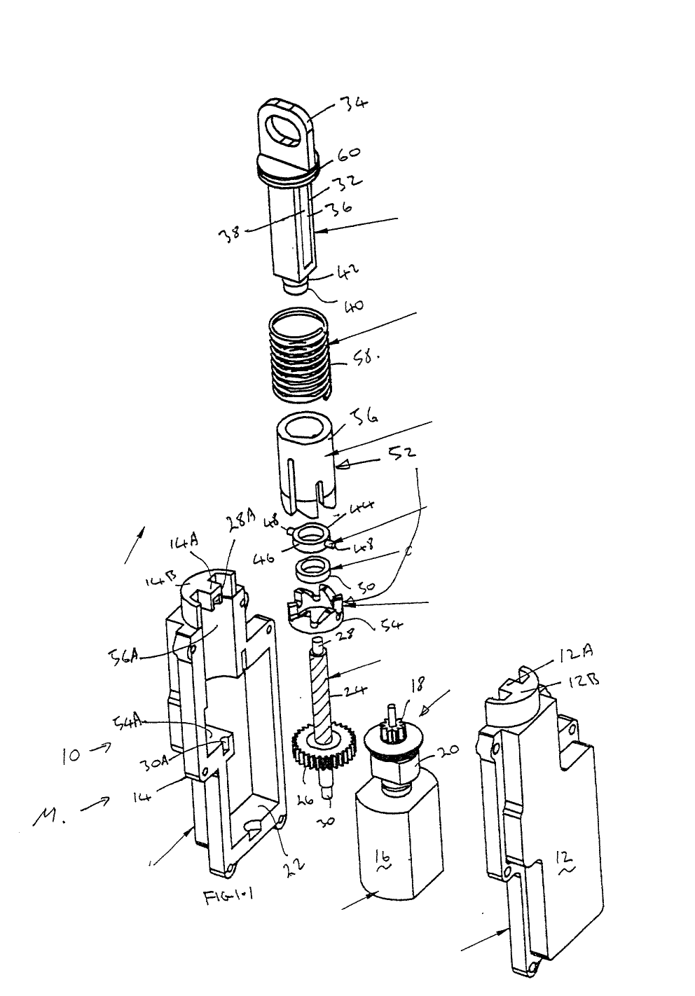

Consideration of FIG. 3 (when compared with FIG. 2) shows that the inside handle 14 has been moved to a transitory position. This in turn has caused link 16, inside release lever 18, extension spring 28, inside lock lever 24, outside lock lever 26 and common release lever 22 to also all move to a transitory position. Note that the outside release lever 20 remains in the same position as shown in FIGS. 1 and 2.

Means M acts in such a manner as to prevent the inside lock lever 24 moving directly from its locked to its unlocked position or from its unlocked position to its locked position.

In particular is should recognised that the unlocked and locked positions of the lock arrangement are stable position, that is to say when the lock arrangement is manually put into either of these position it will remain there. That can be contrasted with the release position wherein when the inside release handle is pulled to that position with the door in an unlocked condition the door latch opens and when the occupant of the vehicle releases the inside handle it returns (usually under the influence of a spring) to the unlocked position. The release position can therefore be said to be an unstable condition. The transitory position is also an unstable conditions (though in further embodiments this need not be the case).

The means M acts such that with the inside lock lever 24 in a locked condition, the inside lock lever must move to the transitory position prior to moving to the unlocked position. Furthermore the means M also acts such that with the inside release lock lever in the unlocked position the inside lock lever must move to the transitory position prior to moving to the locked position.

With this functioning of means M in mind, consideration of FIG. 2 shows that if the inside handle 14 where to be pulled fully to the released position inside lock lever 24 does not move, even as extension spring 28 extends as inside release lever 18 rotates anticlockwise about axis B.

To release a locked door by operation of the inside release handle 14, it is necessary to first push the inside handle to its transitory position which in turn moves link 16, inside release lever 18, extension spring 28, and most notably inside lock lever 24 to their respective transitory positions. Once inside lock lever 24 has achieved its transitory position, means M then allows it to move to its unlocked position as shown in FIG. 1 as the inside handle is returned to its unlocked position. Further movement of the inside handle in an anticlockwise direction to its released position now allows the mechanism to release the latch.

Thus unlatching of the latch from the locked position as shown in FIG. 2 requires three distinct operations to be performed by an occupant of the vehicle, namely:

pushing the inside handle to the transitory position,

releasing the inside handle (whereupon it moves to the unlock position under the influence of a basis spring (not shown)),

pulling the inside handle 14 to the released position.

In particular it can be seen that such an operation requires one pushing operation and a further pulling operation and as such an occupant of the vehicle who merely wishes to unlock the door (but not to unlatch the door) simply has to push the inside handle and is therefore less likely to inadvertently release the latch since this requires a further pull operation.

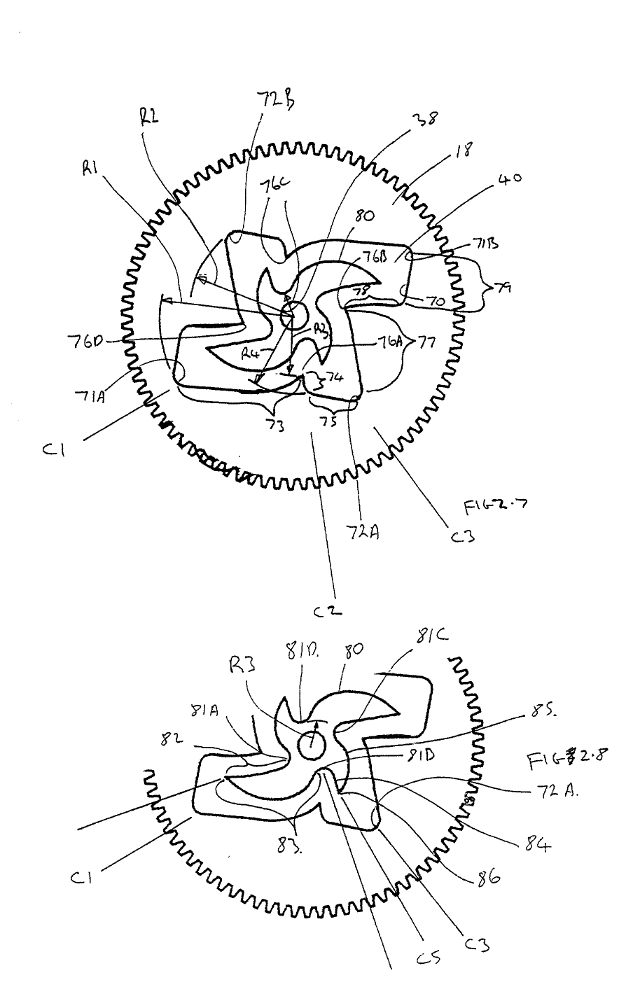

Consideration of FIG. 6 shows a further embodiment of a lock arrangement 110 with components that perform substantially the same function as those in lock arrangement 10 labelled 100 greater.

In this case lock arrangement 110 does not include an extension spring equivalent to extension spring 28. Furthermore inside lock lever 124 has an extension 150 connected to a sill button 151. As shown in FIG. 6 sill button 151 is in a raised unlocked position UL. The lock arrangement 110 can be locked by pressing the sill button to its transitory position T and then releasing the sill button whereupon it will return under the influence of a spring (not shown) to the locked condition L. To unlock the sill button is again pushed to the transitory position T and released whereupon it returns to the unlocked position UL.

Advantageously such an arrangement allows locking/unlocking to be performed by pushing operations. In particular the sill button is not required to be gripped and pulled and this is useful to people who have a weak grip such as the elderly and young children.

It can be seen that the lock arrangement 110 only requires the inside handle 114 to have only two positions namely a released position (not shown) and the position of this component as shown in FIG. 6 which remains the same whether the lock arrangement is in a locked, unlocked or transitory position.

There now follows examples of means for ensuring the actuatable element passes through the transitory position.

With reference to FIG. 1.1 there is shown a means M in the form of an actuator 10 having a right and left hand casing 12 and 14 respectively. A motor 16 is capable of driving pinion 18 via centrifugal clutch 20. The motor, pinion and centrifugal clutch are secured in the casings 12 and 14 in recess 22 (only shown for left hand casing 14). In this case the motor is a DC motor, though other motors would be suitable including a electric stepper motor.

A worm screw 24 is rotationally fast with gear 26. Ends 28 and 30 of the worm screw sit in bearing housing 28A and 30A respectively (only shown on left hand casing 14). Worm screw 24 is thus rotatable within the right and left hand casings but axially fast therein. The actuator further includes an output member in the form of a plunger 32 having a first end 34 for connection to components to be actuated. The plunger includes a body portion 36 having an elongate slot 38. At a second end 40 is a spigot 42 having an internal thread (not shown) for engagement with the worm screw 24.

A shuttle in the form of cam follower 44 has an annular body 46 and two diametrically opposed cam follower pins 48. Cam follower 44 is rotatably mounted on spigot 42 and is retained axially in position by cam follower retainer ring 50 also being mounted on spigot 42 and being axially secured thereto. A caming arrangement 52 is provided by first cam ring 54 and second cam ring 56. Each cam ring is generally cylindrical and has an array of teeth around the circumference of one end.

In this case cam ring 54 has eight teeth T1 (see FIG. 1.3), all identical with each tooth having a tooth edge T2. Between adjacent teeth edges T2 there is provided a cam follower stop S1. In this case the axial height of all teeth edges T2 is the same and the axial height of all cam followers stops S1 is the same. Cam ring 56 also has an array of eight teeth, four of which (T3) are of one profile and the remaining four of which (T4) are of a different profile. It should be noted that the teeth edges T5 of all teeth T3 and T4 are at the same axial position. Cam follower stops S2 and S3 are alternately positioned between teeth T4 and T3 with cam follower stops S2 all being at the same axial position which is different from the axial position of cam follower stops S3.

With the actuator 10 in an assembled condition, pinion 18 engages with gear 26 and worm screw 24 engages with the internally threaded hole (not shown) of spigot 42. As mentioned above, worm screw 24 is axially fast within the right and left hand casings thus rotation of worm screw via the motor 16, centrifugal clutch 20, pinion 18 and gear 26 will cause the plunger 32 to move in an axial direction.

Cam ring 54 and 56 are secured rotationally and axially fast in recesses 54A and 56A of the casings. The outer diameter of annular body 46 is a clearance fit within the bore of cam rings 54 and 56. However, cam follower pins 48 are positioned at a radius that allows them to engage the teeth and cam follower stops of the cam rings 54 and 56.

The plunger 32 is assembled into the casings 12 and 14 such that bosses 12A and 14A of the casing sit within elongate slot 38 thus preventing the plunger 32 from rotating in use. A spring 58 abuts rim 60 of plunger 32 and also abuts boss 12B and 14B of the right and left hand casings to bias the plunger in a upward direction when viewing FIG. 1.1.

Upward movement of plunger 32 is limited by contact between cam follower pins 48 and either cam follower stops S2 (where the plunger is in a raised position when viewing FIG. 1.1) or by contact with cam follower stops S3 (where the plunger is in a mid position when viewing FIG. 1.1).

Operation of the actuator is as follows:

It is assumed the start position of one of the cam follower pins 48 is in position 1 of FIG. 1.2 in abutment with cam follower stop S3 (locked). Therefore the other cam follower pin 48 is in position 1A in abutment with a corresponding cam follower S3.

The motor is energised causing the centrifugal clutch 20 to spin and engage whereupon pinion 18 rotates causing gear 26 to rotate and hence worm screw 24 to rotate. Engagement of worm 24 with the internally threaded hole of spigot 42 causes the plunger to move downwards when viewing FIG. 1.1. This downward movement of the plunger causes the cam following pin 48 to move from position 1 as shown in FIG. 1.2 progressively to position 2 whereupon continued downward movement of the plunger causes the cam follower pin 48 to move downward and leftward when viewing FIG. 1.2 such that it achieves the position 3 (transient position) wherein it is in abutment with cam follower stop S1. At this point the motor is stalled and shortly afterwards the power to the motor is cut.

The spring 58 is under sufficient compression such that it can now lift the plunger and hence the cam follower pin 48 moves progressively from the position 3 through position 4 to position 5 (unlocked) as shown in FIG. 1.2. At position 5 the cam follower pin is in engagement with cam follower stop S2 and this then limits the upward movement of the plunger.

When the motor is subsequently energised again the cam, follower pin 48 moves progressively from position 5 through position 6 to position 7 as shown in FIG. 1.2, and when the power to the motor is cut the cam follower pin 48 moves progressively from position 7 through position 8 to position 9 as shown in FIG. 1.2. It can be seen that with the cam follower pin 48 in either position 1 or position 9 the plunger is at the same axial position since the cam follower pin is at the same axial position.

It can be seen that with each powering of the motor the plunger moves downwards compressing spring 48, and as the power is cut to the motor the plunger moves upwards to one of two heights as spring 58 partially relaxes. Furthermore as the motor is energised the cam follower is caused to rotate through 45 degrees and as the power is cut to the motor the cam follower again rotates in the same direction through a further 45 degrees. Thus four energising/de-energising cycles of the motor will cause the cam follower to rotates through 360 degrees.

It can be seen that when the motor 16 is powered, the plunger 32 always achieves a particular axial position but when the motor is deactivated then the plunger can achieve one of two different axial positions.

The above embodiments demonstrate a way of providing an actuator having differing output positions. Any particular output position can correspond to a powered output position i.e. when the motor is being energised or an at rest position i.e. when the motor has being de-energised. It can be seen it is possible to provide an actuator with differing powered output positions and also differing at rest positions.

Further embodiments may provide for different combinations of powered output position and/or different combinations of rest positions. Furthermore it is clear that each cam arrangement is not limited to only having opposing teeth and it is also clear that the cam follower is not limited to only having two diametrically opposed cam follower.

FIGS. 1.1 to 1.2 show an arrangement with an axially and rotationally fixed caming arrangement which co-operates with a rotatable shuttle in the form of a cam follower. In this case the cam arrangement is in the form of two arrays of teeth on the cam rings which face each other. In an alternative arrangement it is possible to provide a shuttle arrangement rotatably on the plunger with two arrays of teeth which face away from each other and to provide two sets of cam followers, one set for each array of teeth, which are rotatably and axially fixed on the casings.

FIG. 1.3 shows a schematic view of a further embodiment of the present invention in which a shuttle 444 is provided with an array of teeth 445 and a cam follower 446. A caming arrangement is provided by an array of teeth 447 and a cam follower 448, both of which are fixed axially and rotatably fast. The shuttle moves between the teeth 447 and cam follower 448 and is caused to rotate by engagement between teeth 447 and cam follower 445 and by engagement between teeth 445 and cam follower 448.

It can be seen that the cam follower pins of FIGS. 1.1 to 1.3 provide the two functions, namely that of indexing the cam follower rotationally and also of providing stop abutment with the plunger. In alternative embodiments these two functions need not be provided by the same component, thus cam follower pin could solely provide the means for indexing the cam follower rotationally and the axial position of the plunger could be defined an alternative stop arrangement.

Furthermore the preceding description has described how by energising and deactivating a motor, the various output positions can be achieved. It should be noted that it is also possible to achieve any particular output position by applying a force to the plunger, in particular a manual force. Thus sequential pressing and release of for example the plunger 32 of FIG. 1.1 in a downwards direction will cause the cam follower retaining ring to index around allowing the plunger to achieve, in particular, the two at rest output conditions (locked and unlocked). It can be seen that the plunger must pass through the transient condition (position 3 of FIG. 1.2) to change between the locked and unlocked positions.

It should be noted that depending upon the installation, the motor 16 need not necessarily have a centrifugal clutch 20. Furthermore where the means N is not required to be powered, the motor 16 can simply be removed from the casing. This provides for a simply way of providing a powered means and non powered means.

There now follows further examples of means for ensuring the actuatable element passes through the transitory position.

With reference to FIGS. 2.1 to 2.7 there is shown a means M in the form of an actuator 10 including a housing 12, a motor 14, a pivot pin 16, a cam wheel 18 and an output member 20, a housing cover 22 and a spring 24. Housing 12 includes a motor recess 26 and a cam wheel recess 28. Motor assembly 14 includes a motor 30 driveably connectable to an output pinion 32 via a centrifugal clutch 34. Cam wheel 18 includes an array of teeth 36 for engagement with output pinion 32, and a central hole 38 to allow the cam wheel to be pivotably mounted on pivot pin 16. Cam wheel 18 further includes a recess 40 which will be described further below.

Housing cover 22 is generally planar in form and includes a recess (not shown) within boss 42 to receive shaft 31 of motor assembly 14, a recess (not shown) corresponding to cam wheel recess 28, and a lever recess (not shown) within boss 44 to allow the output lever to rotate as will be described further below.

Output member 20 includes levers 46 and 48 and pivot pin 50. Lever 46 includes a cam follower 52 at one end thereof for engagement with recess 40 and a hole 54 at the other end thereof, profiled in such a manner as to engage end 50A of pin 50 in a press fit and rotationally fast manner.

Lever 48 includes a hole 56 at one end thereof connectable in use to a component (not shown) to be actuated. A hole 58 is positioned at the other end of lever 48, profiled to engage in a press fit manner and rotationally fast with end 50B of pivot pin 50. Lever 48 further includes a spring hole 60 through which ends 24A of spring 24 passes. The other end 24B of spring 24 is inserted into spring hole 62 of boss 44.

When assembled:

Motor assembly 14 sits in motor recess 26 with shaft 21 engaging and being supported by the hole within boss 42. Cam wheel 18 sits in recess 28 and the corresponding recess (not shown) of cover 22 with the array of gear teeth 36 in engagement with pinion 32, and central hole 38 being mounted on pivot pin 16 which in turn is mounted in hole 29 of housing 12 and a corresponding hole (not shown) beneath boss 44.

The output member is assembled such that a part of mid portion 51 of pivot pin 50 is pivotally mounted within hole 45 of boss 44, and spring 24 is mounted around an adjacent part of mid portion 51. In particular spring 24 is arranged such that the output member 20 is biased in a clockwise direction when viewed in the direction of arrow A i.e. cam follower 52 is biased in a radially outward direction relative to the axis 16A of pivot pin 16.

When motor 30 is energised the centrifugal clutch 34 will engage, hence driving pinion 32 in an anticlockwise direction when viewed in the direction of arrow A causing the cam wheel to rotate in a clockwise direction when viewed in the direction of arrow A. This rotation of the cam wheel will cause the cam follower 52 to follow the profile of recess 40 and cause the output member to pivotally reciprocate as will be described further below.

Furthermore external reciprocation of the output member 20 (e.g. by manual reciprocation) will cause the cam follower 52 to drive the cam wheel 18 in a clockwise direction. Such rotation causes output pinion 32 to also rotate, though motor 30 is not rotated since the centrifugal clutch 34 is not engaged.

Consideration of FIG. 2.7 shows the cam wheel 18 in more detail. In particular recess 40 includes an outer wall 70 and an inner wall 80 which together form a cam. Outer wall 70 includes two first stops 71A and 71B both located at radius R1 from axis A. Outer wall 70 further includes stops 72A and 72B, both located at radius R2 from axis A. Note that radius R2 is smaller than radius R1. Stops 71A, 71B, 72A and 72B act to limit the outward movement of the cam follower. The profile of the outer wall 70 between stop 71A and 72A is split into three distinct portions 73, 74 and 75. Spirally curved portion 73 starts at stop 71A at circumferential position C1 and spirals inwards to edge 76A at radius R3 and circumferential position C2. It should be noted that radius R3 is less than radius R1.

For the avoidance of doubt term inward spiral refers to a curved traced by a point which rotates about a fixed position towards which it continually approaches, and the term outward spiral should be construed accordingly. In particular a straight line is a special form of curve and the term spiral curve includes for example and embodiment wherein stop 71A is connected to edge 76A by a straight line.

It should be noted that the exact form of spirally curved portion 73 can be varied, for example it could be part of an archimedian spiral, part of a circle, part of an ellipse, or other forms. The significant point is that point 76A is circumferentially displaced from stop 71A and is radially closer to axis A than stop 71A.

Portion 74 is substantially radially orientated. Portion 75 comprises an outward spirally curved portion. The portion of outer wall between stop 72A and 71B has equivalent inwardly spirally curved portion 77, substantially radially orientated portions 78 and outwardly spirally curved portion 79.

In particular it should be noted that portion 78 should be regarded as a substantially radially orientated portion even though in fact it is part of an arc, the centre of which is the axis of pivot pin 70 when the cam follower is situated adjacent this portion of the outer wall. The form of portion 78 thus allows the cam follower to move substantially radially relative to axis A without causing the cam wheel to rotate. Three corresponding portions (not marked for clarity) can be identified between stop 71B and stop 72B and three corresponding portions (not marked for clarity) can be identified between stop 72B and stop 71A.

With reference to FIG. 2.8 it can be seen that inner wall 80 includes third stops 81A, 81B, 81C and 81D, all positioned at radius R3 from axis A. Consideration of the outer wall profiled between stop 81A and 81B shows a substantially radially orientated portion 82 and an inwardly spirally curved portion 83.

The profile of the inner wall between stops 81B and 81C includes a substantially radially orientated portion 84 and an inwardly spirally curved portion 85. Equivalent portions (not marked for clarity) can be identified between stops 81C and 81D and also between stops 81D and 81A. It should be noted that the circumferential position C4 of inner stop 81B is circumferentially between the circumferential positions C1 and C3 of outer stops 71A and 72A respectively.

Furthermore it can be seen that the circumferential position C4 of stop 81b is circumferentially offset (mis-aligned) from edge 86 (positioned at circumferential position C5) edge 86 is also circumferentially offset from stop 72a (compare positions C5 and C3).

Powered operation of the actuator is as follows:

Consideration of FIG. 2.3 shows the actuator in a stationary position with the cam follower 52 being biased in a radially outward direction by spring 24. Cam 52 is limited in its outward movement by engagement with stop 72A.

The motor is energised such that the cam wheel is caused to rotate in a clockwise direction whereupon portions 77, 78 and 79 progressively move past cam follower 52. As portion 77 moves pass cam follower 52 the cam follower progressively moves radially inwardly relative to axis A causing the output member 20 to rotate in an anticlockwise direction about axis B.

As the end of portion 77 adjacent portion 78 moves pass cam follower 52, the output member ‘snaps’ clockwise under the influence of spring 24 until such time as the cam follower 52 abuts the end of portion 79 adjacent portion 78. Continued rotation of the cam wheel 18 in a clockwise direction causes the portion 79 to move pass cam follower 52 until such time as the actuator achieves the position as shown in FIG. 2.4 whereupon cam follower 52 engages stop 71B.

It should be noted that due to the radial difference between stop 72A and 71B the output member 20 is in a different position when comparing FIGS. 2.3 and 2.4. It should be noted that motor 30 is energised with a pulse of predetermined duration and provided that edge 76A has passed under cam follower 52 and provided that edge 76B has not passed under cam follower 52 then whenever the pulse of energy ceases with the cam follower between these two edges, the spring 24 will cause the cam wheel to return or advance to the position as shown in FIG. 2.4 since this is the radially outer most position achievable by the cam follower between edges 76A and 76B.

A further pulse of energy to motor 30 will cause stop 72B to move beneath the cam follower. Note that at this position the output member 20 will be in the position as shown at FIG. 2.3 but the cam wheel will be rotated 180 degrees from the position as shown in FIG. 2.3. A further pulse of energy to the motor will move stop 71A beneath cam follower 52 and a yet further pulse of energy will move stop 72A beneath cam follower 52 returning the actuator to the position as shown in FIG. 2.3.

Note that during powered operation cam follower 52 only need engage the outer wall 70 and no contact is required between cam follower 52 and inner wall 80.

It is possible to externally actuate the output member 20 to rotate the cam wheel 18 under these circumstances the sequence of movements are shown sequentially in FIG. 2.3, FIG. 2.5, FIG. 2.4 and FIG. 2.6.

Thus manual actuation of the output member 20 in an anticlockwise direction about axis B causes cam follower 52 to disengage the outer wall and engage the inner wall at portion 85, since edge 86 is circumferentially offset from stop 72A. Continued anticlockwise movement of output member 20 results in cam follower 52 moving substantially radially inwardly relative to axis A causes a camming action between cam follower 52 and portion 85 resulting in clockwise rotation of cam wheel to the position as shown in FIG. 2.5, whereupon cam follower 52 engages stop 81C.

Release of output member 20 results in output member snapping clockwise under the influence of spring 24 until such time as cam follower 52 engages an end of portion 79 of the outer wall. Spring 24 continues to basis cam follower 52 in a radially outward direction resulting in the camming action between cam follower 52 and portion 79 until such time as the actuator achieves the position as shown in FIG. 2.4.

A further manual actuation of the output member in an anticlockwise direction about axis B causes cam follower 52 to disengage the outer wall and engage the inner wall at portion 80 causing the actuator to move to the position as shown in FIG. 2.6. Subsequent release of the output member will cause this component to move to the position as shown in FIG. 2.3 under the influence of spring 24 (though it should be noted that the cam wheel will be positioned 180 degrees from the position as shown in FIG. 2.3).

Thus it can be seen that progressive pulses of energy to the motor can cause the output member to move between the position as shown in FIGS. 2.3 and 2.4. Furthermore the output member can be caused to move between these two positions by successive manual or other external actuation of the output member 20.

As mentioned above, the spring 24 acts to bias the cam follower radially outwardly relative to the cam wheel axis. A person skilled in the art would readily appreciate that it is also possible to arrange the spring to bias the cam follower radially inwardly and to provide an appropriate cam formation. Note that recess 140 is of a different profile to recess 40. Any form of motor can be used but in particular DC electric motors are particularly suitable as are electric stepper motors.

The embodiment described show a cam follower in the form of a pin which is positioned in a groove which provides for the cam profile. In further embodiments different cam profile and cam follower arrangements could be used in particular a twin pronged fork cam follower could be used with a fork being provided on either side of a rail, the rail being shaped to provide the cam profile

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specially described. For that reason the following claims should be studied to determine the true scope and content of this invention.

What is claimed is:

1. A lock arrangement comprising: a lock having an unlocked and a locked condition, the lock arrangement further including an actuable element having a first position at which the lock is in said unlocked condition and a second position at which the lock is in said locked condition, the lock arrangement further including a mechanism for ensuring the actuable element passes through a transitory position in changing the state of the lock from at least one of the locked and the unlocked conditions to the other of the locked and the unlocked conditions in which one of the first and second positions of the actuable element is on the path of the actuable element between the transitory and the other of the first and second positions.

2. The lock arrangement as defined in claim 1 in which the mechanism ensures the actuable element passes through the transitory position when changing the state of the lock from the locked condition to the unlocked condition.

3. The lock arrangement as defined in claim 1 in which the mechanism ensures the actuable element passes through the transitory position when changing the state of the lock from the unlocked condition to the locked condition.

4. The lock arrangement as defined in claim 1 in which the actuable element is biased away from the transitory position.

5. The lock arrangement as defined in claim 1 in which the mechanism has an output element having a first, a second and a transitory positions corresponding to the first, the second and the transitory positions of the lock arrangement, the first, the second and the transitory positions of the mechanism being in line on an axis.

6. The lock arrangement as defined in claim 5 in which the mechanism includes a shuttle rotatably indexable about the axis during movement between the first and the transitory position or the second and the transitory position of the mechanism, the shuttle acting as a stop to provide the first, the second and the transitory positions.

7. The lock arrangement as defined in claim 6 in which the shuttle is a cam follower movable between opposing arrays of cam teeth.

8. The lock arrangement as defined in claim 6 in which the shuttle includes a cam follower and an array of cam teeth and moves between an array of teeth which oppose a further cam follower.

9. The lock arrangement as defined in claim 6 in which the shuttle includes two array of cam teeth which move between opposing cam followers.

10. The lock arrangement as defined in claim 1 in which the mechanism has an output element having a first, a second and a transitory positions corresponding to the first and the second and the transitory positions of the lock arrangement, the first, the second and the transitory positions of the mechanism being an arc of a circle.

11. The lock arrangement as defined in claim 10 in which the mechanism includes a cam follower pivotable about a center of the arc which engages a cam rotatable about a cam axis different from the center of the arc.

12. The lock arrangement as defined in claim 11 in which the cam includes a first and a second stop corresponding to the first and the second positions of the output element.

13. The lock arrangement as defined in claim 12 in which the stops limit radially outward movement of the cam follower relative to the cam.

14. The lock arrangement as defined in claim 13 in which the stops limit radially inward movement of the cam follower relative to the cam.

15. The lock arrangement as defined in claim 11 in which the cam includes a transitory position stop corresponding to the transitory position of the output element.

16. The lock arrangement as defined in claim 15 in which the transitory position stop limits radially inward movement of the cam follower relative to the cam.

17. The lock arrangement as defined in claim 15 in which the transitory stop limits radially outward movement of the cam follower relative to the cam.

18. The lock arrangement as defined in claim 1 in which the mechanism includes a motor operable to change the state of the lock.

19. The lock arrangement as defined in claim 18 in which the motor is powered in a single direction to move the actuable element from the locked to the unlocked condition and from the unlocked to the locked condition.

20. The lock arrangement as defined in claim 18 in which the mechanism has an output element having a first, a second and a transitory positions corresponding to the first, the second and the transitory positions of the lock arrangement, the first, the second and the transitory positions of the mechanism being in line on an axis and a shuttle rotatably indexable about the axis during movement between the first and the transitory position or the second and the transitory position of the mechanism, the shuttle acting as a stop to provide the first, the second and the transitory positions, in which the mechanism includes a motor operable to change the state of the lock and in which the motor drives the shuttle.

21. The lock arrangement as defined in claim 18 in which the mechanism has an output element having a first, a second and a transitory positions corresponding to the first and the second and the transitory positions of the lock arrangement, the first, the second and the transitory positions of the mechanism being an arc of a circle and includes a cam follower pivotable about a center of the arc which engages a cam rotatable about a cam axis different from the center of the arc, in which the mechanism includes a motor operable to change the state of the lock and in which the motor drives the cam.

22. The lock arrangement as defined in claim 1 in which the actuable element is a sill button.

23. The lock arrangement as defined in claim 1 in which the lock arrangement acts to lock a latch in which the actuable element further has a release position at which the latch is released.

24. The lock arrangement as defined in claim 23 in which the actuable element is an inside door handle.
